(19) United States
(12) Patent Application Publication
(10) Pub. No.: US 2010/0121859 A1
(43) Pub. Date: May 13, 2010

(54) WORKFLOW MANAGEMENT SYSTEM, WORKFLOW MANAGEMENT CONTROL METHOD, AND COMPUTER-READABLE RECORDING MEDIUM STORING WORKFLOW MANAGEMENT CONTROL PROGRAM

(76) Inventors: Kaoru Maeda, Kanagawa (JP); Takeshi Suzuki, Kanagawa (JP); Heiko Maus, Kaiserslautern (DE); Harald Holz, Kaiserslautern (DE); Oleg Rostanin, Kaiserslautern (DE)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/554,210

(22) Filed: Sep. 4, 2009

(30) Foreign Application Priority Data
Sep. 8, 2008 (JP) 2008-230006
Aug. 4, 2009 (JP) 2009-181878

(51) Int. Cl. G06F 17/30; G06F 17/00; G06F 9/46

(52) U.S. Cl. 707/748; 718/102; 707/769; 707/E17.014; 707/608; 707/E17.008

(57) ABSTRACT

A workflow management system for managing a constructive workflow includes a storing unit, to which a user inputs a search condition to search for documents relevant to a target task and tasks neighboring to the target task, and which stores the input search condition in a query database by causing the condition to relate to the target task, a search condition obtaining unit which obtains a search condition to search for the documents relevant to the target task from the query database when the documents relevant to the target task are requested to be searched for, a restructuring unit which restructures the obtained search condition to a search condition having a predetermined format by considering a type and a weighting factor of the type included in the obtained search condition, and a searching unit which obtains a list of documents from a document database based on the restructured search condition.

### BACKGROUND OF THE INVENTION

1. Field of the Invention

The present invention generally relates to a workflow management system, a workflow management control method in the workflow management system, and a computer-readable recording medium storing a workflow management control program for executing the workflow management control method.

2. Description of the Related Art

A conventional workflow management system (task flow management system) needs to determine a workflow model before executing a workflow. That is, in the conventional workflow management system, a processing sequence relationship among tasks of which a workflow is formed and details of the tasks must be determined beforehand.

However, in fields where information is not sure beforehand such as a research and development field and a part of a service offering field, a workflow model is hardly determined beforehand. In the above fields, the following situations frequently occur; that is, when a workflow is executed, a new task may be added, an executing sequence of tasks may be changed, and an assumed task may not be needed. Consequently, it is very difficult to determine a fixed work model beforehand.

In order to solve the above problem, a so-called constructive workflow has been developed in which a workflow model is dynamically formed when a workflow is executed. That is, in the constructive workflow, a structure of tasks can be dynamically changed.

In addition, in the constructive workflow, in order to increase the productivity when tasks are executed, a workflow management system has been proposed in which various information items (relevant information) to be required when a workflow is executed can be proactively searched for and obtained during the execution of the tasks (for example, see Patent Documents 1 through 4).

On the other hand, in a document search technology, a ranking search technology has been generally used in which documents highly related to a task are arranged in descending order in the search result list (for example, see the Apache Lucene Project; http://lucene.apache.org/).

[Patent Document 1] Japanese Unexamined Patent Publication No. 2007-188145

[Patent Document 2] Japanese Unexamined Patent Publication No. 2008-65784

[Patent Document 3] Japanese Unexamined Patent Publication No. 2008-71082

[Patent Document 4] Japanese Unexamined Patent Publication No. 2008-71083

The conventional constructive workflow provides a function in which the various information items to be required when a workflow is executed are proactively searched for and obtained; however, the following problems occur.

First, in the search, since a word (a phrase) including in bibliographic information of a task is mainly used, a range of documents to be hit by the search is limited to a certain range; therefore, in some cases, effective information may not be obtained.

Second, since a search condition used before is not retained to be reused, the search condition must be input each time. Consequently, the operation is bothersome. The search condition can be easily stored; however, the search condition can be reused only in the same task as the task used before, and the search condition cannot be used in a task different from the task used before.

Third, even if the search condition has been stored, when bibliographic information of a task and/or a document attached to the task is updated, the stored search condition becomes meaningless and a normal search result cannot be obtained by the stored search condition.

### SUMMARY OF THE INVENTION

In a preferred embodiment of the present invention, there is provided a workflow management system, a workflow management control method in the workflow management system, and a computer-readable recording medium storing a workflow management control program for executing the workflow management control method, in which information relevant to a task can be widely searched for and obtained, a search condition can be reused among tasks, a newest search condition on which changes in various information items are reflected can be used when a relevant document is searched for even if the bibliographic information and a document attached to the task are updated.

Features and advantages of the present invention are set forth in the description that follows, and in part will become apparent from the description and the accompanying drawings, or may be learned by practice of the invention according to the teachings provided in the description. Features and advantages of the present invention will be realized and attained by a workflow management system, a workflow management control method in the workflow management system, and a computer-readable recording medium storing a workflow management control program for executing the workflow management control method particularly pointed out in the specification in such full, clear, concise, and exact terms so as to enable a person having ordinary skill in the art to practice the invention.

To achieve one or more of these and other advantages, according to one aspect of the present invention, there is provided a workflow management system, which manages a constructive workflow, in which procedures of processes are expressed in a hierarchical structure by recursive decomposition of plural tasks each of which is a unit of the process, and the constructive workflow is capable of executing at least one of adding, editing, and deleting a task while processing the procedures. The workflow management system includes a storing unit, to which a user inputs a search condition to search for documents relevant to a target task and tasks neighboring to the target task, and which stores the input search condition in a query database by causing the input search condition to relate to the target task, a search condition obtaining unit which obtains a search condition to search for the documents relevant to the target task from the query database when the documents relevant to the target task are requested to be searched for, a restructuring unit which restructures the obtained search condition to a search condition having a predetermined format by considering a type and a weighting factor of the type included in the obtained search condition, and a searching unit which obtains a list of documents from a document database based on the restructured search condition.

### BRIEF DESCRIPTION OF THE DRAWINGS

Features and advantages of the present invention will become more apparent from the following detailed description when read in conjunction with the accompanying drawings, in which:

FIG. 1 is a diagram showing a workflow and tasks in a hierarchical structure;

FIG. 2 is a diagram showing neighboring tasks in the hierarchical structure;

FIG. 3 is a diagram showing an example of a structure of a workflow management system according to an embodiment of the present invention;

FIG. 4 is a diagram showing an example of a hardware structure of an element by which the workflow management system is realized;

FIG. 5 is a diagram showing an example of a data structure of a task instance DB (database) shown in FIG. 3;

FIG. 6A is a diagram showing an example of a data structure of a query DB shown in FIG. 3;

FIG. 6B is a diagram showing an example of a correspondence relationship among a query type, a query parameter, and a search condition/keyword extracting process in the query DB;

FIG. 7 is a diagram showing an example of a hierarchical structure of tasks including a relationship between search conditions and attached documents;

FIG. 8 is a diagram showing a specific example of the query DB;

FIG. 9 is a diagram showing an example of a search result displaying screen displayed by a user interface shown in FIG. 3;

FIG. 10 is a diagram showing an example of a search condition determination screen displayed by the user interface;

FIG. 11 is a sequence chart of a process example according to the embodiment of the present invention;

FIG. 12 is a sequence chart of another process example according to the embodiment of the present invention;

FIG. 13 is a flowchart showing an example of a search condition obtaining process shown in FIG. 11 by a workflow engine shown in FIG. 3;

FIG. 14 is a diagram showing an example of a fixed weighting factor search condition according to the embodiment of the present invention;

FIG. 15A is a first flowchart showing an example of a weighting factor calculating process shown in FIGS. 11 and 12 by the workflow engine;

FIG. 15B is a second flowchart showing the example of the weighting factor calculating process shown in FIGS. 11 and 12 by the workflow engine;

FIG. 16 is a diagram showing a specific example of a weighting factor calculation according to the embodiment of the present invention;

FIG. 17A is a diagram showing an example of a search condition group in which the fixed weighting factor search condition shown in FIG. 14 is applied to a target task to which information is supplied;

FIG. 17B is a diagram showing an example of contents in the query DB;

FIG. 17C is a diagram showing a result retention sequence when the weighting factor calculating process shown in FIG. 15 is applied to the examples shown in FIGS. 17A and 17B;

FIG. 18 is a flowchart showing a process example in which a search condition is converted into a keyword according to the embodiment of the present invention;

FIG. 19A is a diagram showing a specific example of the search condition group which contains arguments at a starting time of conversion of search conditions into keywords according to the embodiment of the present invention;

FIG. 19B is a diagram showing specific examples of keywords to be extracted in the middle of the conversion; and

FIG. 19C is a diagram showing a specific example of a result retention sequence in which the weighting factors and the keywords are shown.

### DESCRIPTION OF THE PREFERRED EMBODIMENTS

### Best Mode of Carrying Out the Invention

The best mode of carrying out the present invention is described with reference to the accompanying drawings.

### Definition

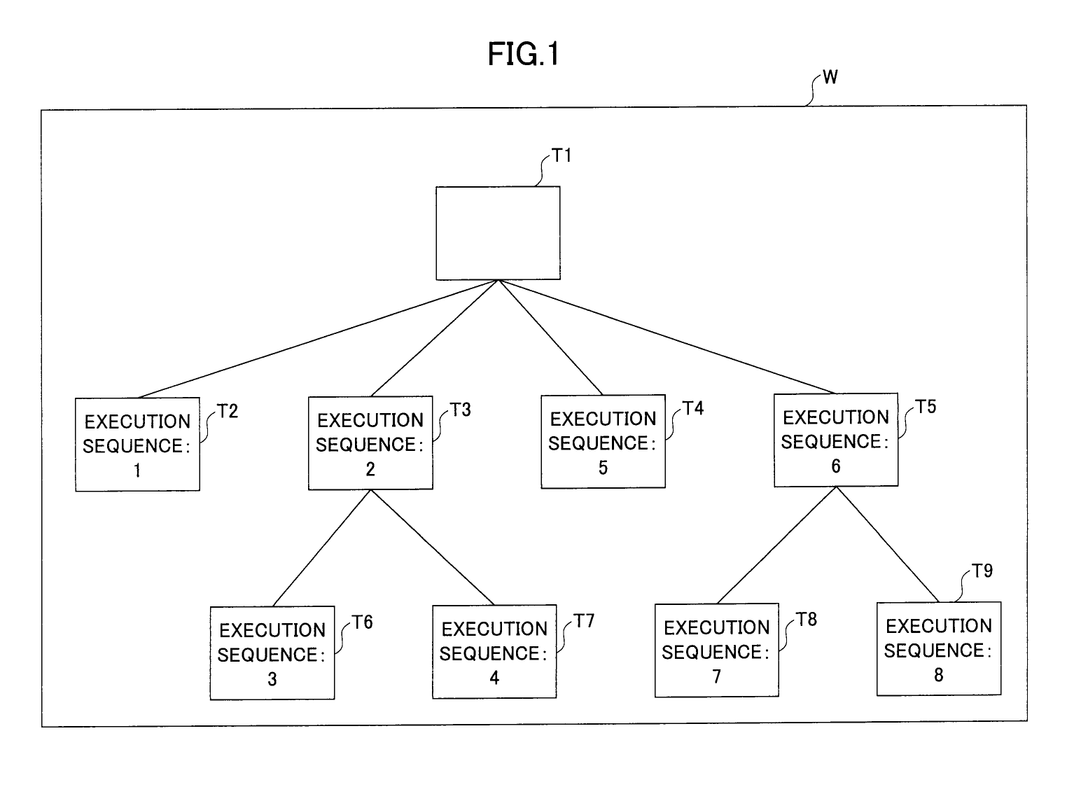

FIG. 1 is a diagram showing a workflow and tasks in a hierarchical structure.

The workflow shows a processing procedure of a sequence of tasks. The task is one process unit and an element (a step in the processing procedure) and the workflow is formed of the tasks. The task has a name, a person to execute the task, a staring time and date and an ending time and date of the task, a status of the task, and so on as properties. In FIG. 1, a workflow W is formed of tasks T1 through T9.

A constructive workflow shows the processing procedure as a tree structure (hierarchical structure) by recursive decomposition of tasks. In the constructive workflow, a task can be added to the workflow, can be edited in the workflow, and can be deleted from the workflow during the execution of the workflow.

A subtask is formed by decomposing the process in the task into small processes. On the workflow, a parent-child relationship is formed between a task whose process is to be decomposed and subtasks formed by the decomposition in a hierarchical relationship, and the task whose process is to be decomposed is a parent task and each of the subtasks is a child task. The parent task is a task positioned at an upper level and the child task is the subtask positioned at a lower level in the hierarchical structure. When all the subtasks are processed, the task is completed.

Each task (subtask) has at most one parent task. A task which does not have a parent task is called a root task. The root task represents the total of the workflow.

When tasks decomposed in a hierarchical structure are executed, the workflow is performed. The execution sequence (execution order) can be specified independent of the parent-child relationship (not shown in FIG. 1). In FIG. 1, the execution sequence of tasks is defined as T2→T3→T6→T7→T4→T5→T8→T9.

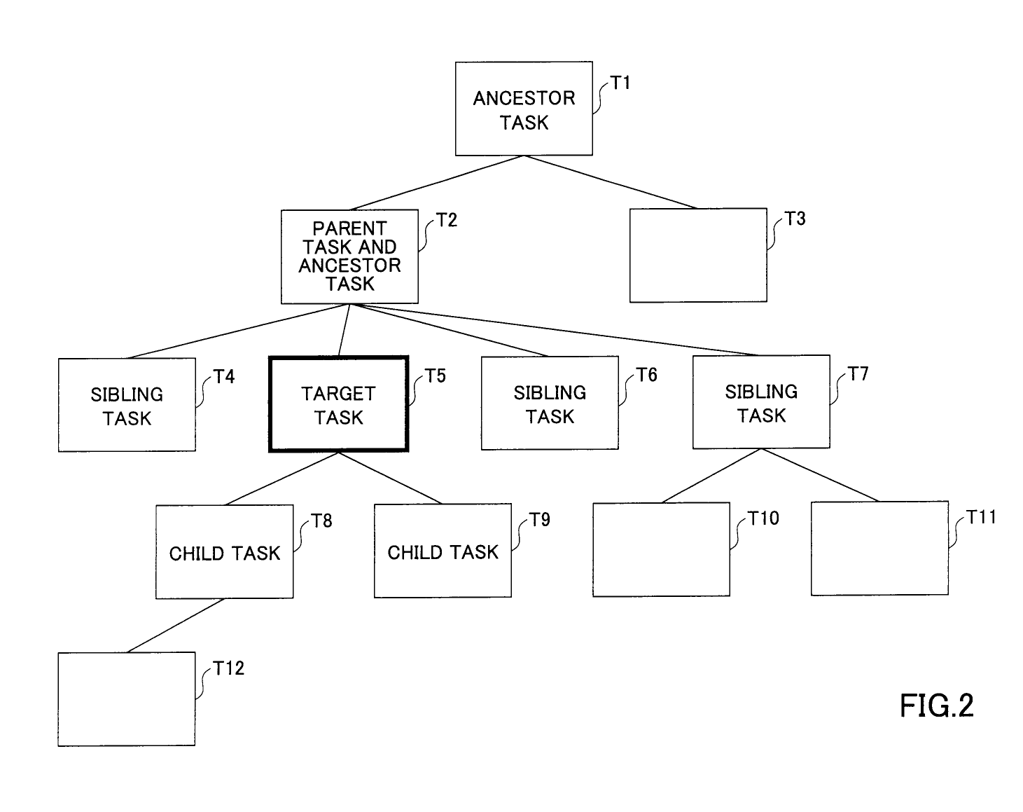

FIG. 2 is a diagram showing neighboring tasks in the hierarchical structure.

The neighboring tasks are related to a target task in a parent-child relationship described by property values of a parent task ID and a child task ID, and have a generic upper concept of a parent task, a child task, an ancestor task, and a sibling task described below.

The parent task has a value to be shown by a property value “parent ID” for a target task as a task ID. The parent task has a parent-child relationship with the target task, and is at a one step upper position in the hierarchical structure. In FIG. 2, when the task T5 is defined as the target task, the task T2 is the parent task.

The child task is positioned under the target task whose property value is “parent ID” for the child task. The child task has a parent-child relationship with the target task, and is at a one step lower position in the hierarchical structure. In FIG. 2, when the task T5 is defined as the target task, each of tasks TB and T9 is the child task.

The sibling task has a common parent task with the target task. In FIG. 2, when the task T5 is defined as the target task, tasks T4, T6, and T7 are the sibling tasks.

The ancestor tasks are the parent tasks on a route from the target task to a root task and include the root task. That is, the parent task is the ancestor task. In FIG. 2, when the task T5 is defined as the target task, tasks T2 and T1 are the ancestor tasks.

[Structure]

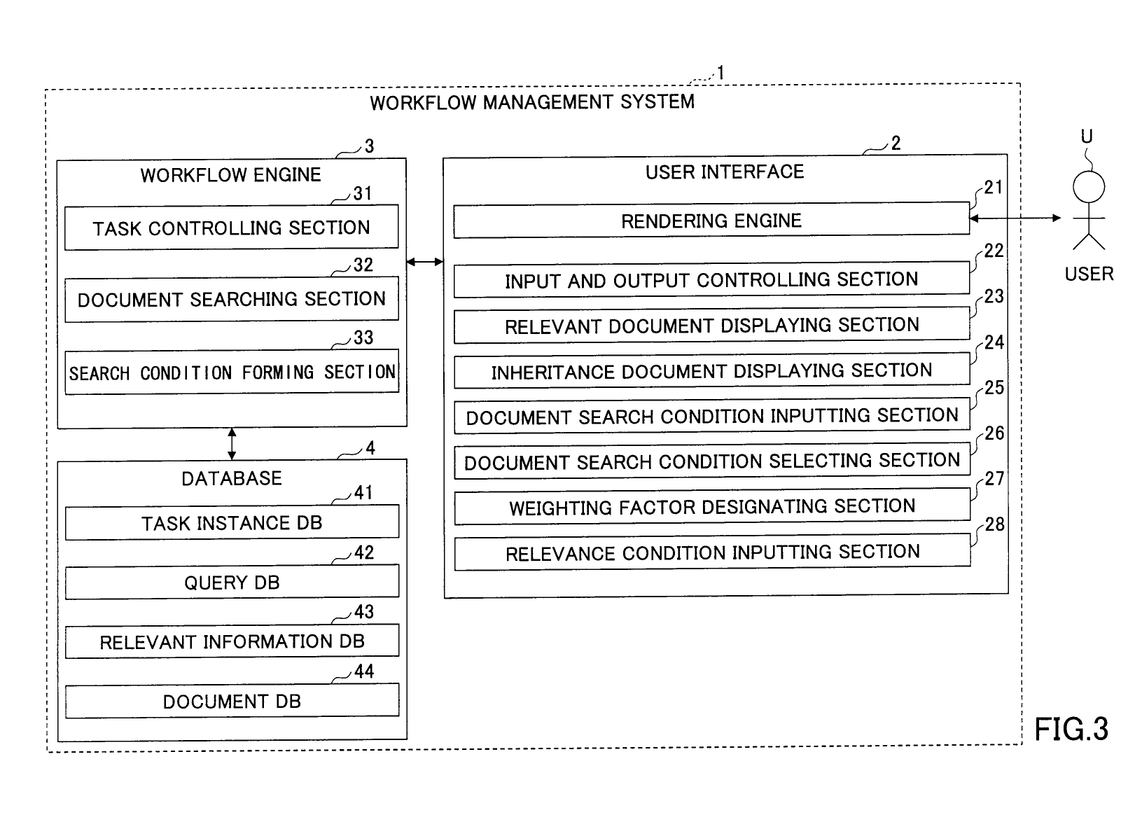

FIG. 3 is a diagram showing an example of a structure of a workflow management system according to an embodiment of the present invention.

As shown in FIG. 3, a workflow management system 1 includes a user interface 2 which operates Web browser in, for example, a PC (personal computer) to be operated by a user U, a workflow engine 3 which is operated by, for example, an application server, and a database 4 which is operated by, for example, a database server.

The user interface 2 includes a rendering engine 21 which applies rendering to an image, and an input and output controlling section 22 which controls an input to and an output from the workflow engine 3.

The user interface 2 further includes a relevant document displaying section 23 which displays a relevant document by using a GUI (graphical user interface). The relevant documents include a document directly relevant to a target task to which information is supplied and a document which is searched for under a predetermined search condition.

The user interface 2 further includes an inheritance document displaying section 24 which displays an inheritance document through the GUI. The inheritance document is a relevant document of an ancestor task of a target task and is inherited by the target task from the ancestor task.

The user interface 2 further includes a document search condition inputting section 25 by which the user U inputs a search condition through the GUI, a document search condition selecting section 26 by which the user U selects a search condition through the GUI, a weighting factor designating section 27 by which the user U designates a weighting factor to each of the search conditions through the GUI, and a relevance condition inputting section 28 by which the user U inputs a relevance condition through the GUI. The weighting factor designates weights for the search conditions. The relevance condition designates to further search for another document similar to a designated document in a search result list. That is, relevance feedback is executed by the relevance condition. Screen examples on which the search condition is input and selected are described below.

The database 4 includes a task instance DB (database) 41 which stores specific task instances, a query DB 42 which stores search conditions related to each task instance stored in the task instance DB 41, a relevant information DB 43 which stores relevant information to be referred to when a workflow is executed, and a document DB 44 which stores documents themselves containing the relevant information.

The workflow engine 3 includes a task controlling section 31 for controlling (forming, executing, and so on) the tasks in the workflow, a document searching section 32 (search engine) for executing various searches in the database 4, and a search condition forming section 33 for automatically forming the search conditions in the workflow management system 1. The document searching section 32 also executes a search with a rank.

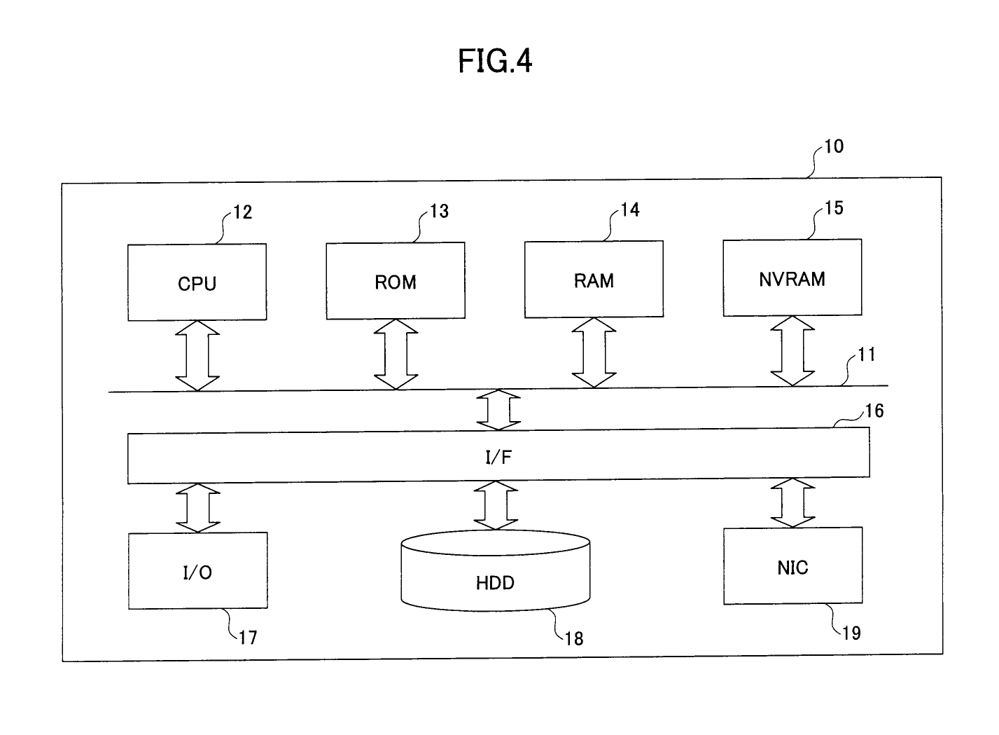

FIG. 4 is a diagram showing an example of a hardware structure of an element by which the workflow management system 1 is realized. That is, in FIG. 4, a computer 10 is shown as the PC (the hardware structure) to operate the user interface 2, as the application server to operate the workflow engine 3, and the database server to operate the database 4. As shown in FIG. 4, the computer 10 includes a CPU (central processing unit) 12, a ROM (read only memory) 13, a RAM (random access memory) 14, and an NVRAM (non-volatile RAM) 15 connected to a system bus 11; an I/F (interface) 16 connected to the system bus 11; and an I/O (input/output device) 17 including a keyboard, a mouse, a monitor, and so on, an HDD (hard disk drive) 18, and a NIC (network interface card) 19 connected to the I/F 16.

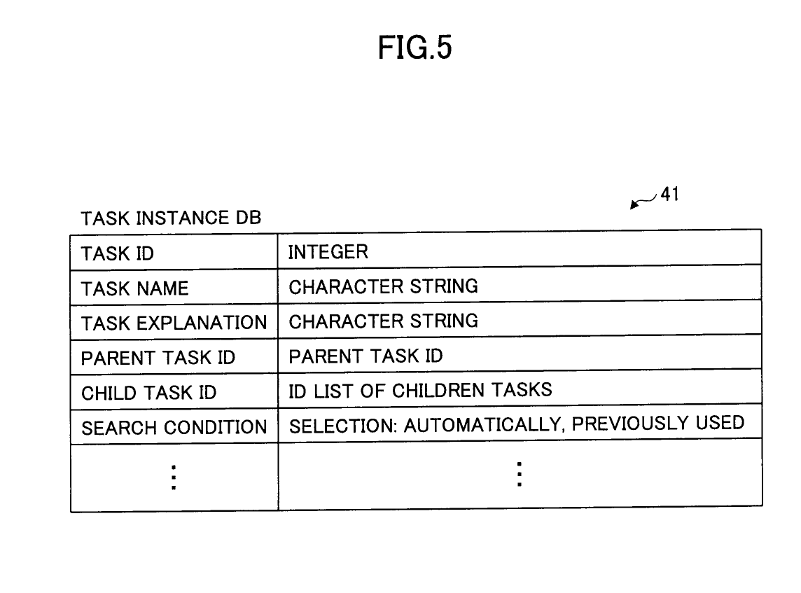

FIG. 5 is a diagram showing an example of a data structure of the task instance DB 41. The task instance DB 41 includes a task ID for identifying a task, a task name for showing a name of the task, a task explanation for showing an outline of the task, a parent task ID for showing an ID of a parent task of the task, a child task ID for showing an ID of a child task (IDs of children tasks) of the task, and a search condition whether a document is automatically searched for by using a fixed weighting factor, or by using a search condition stored in the query DB 42.

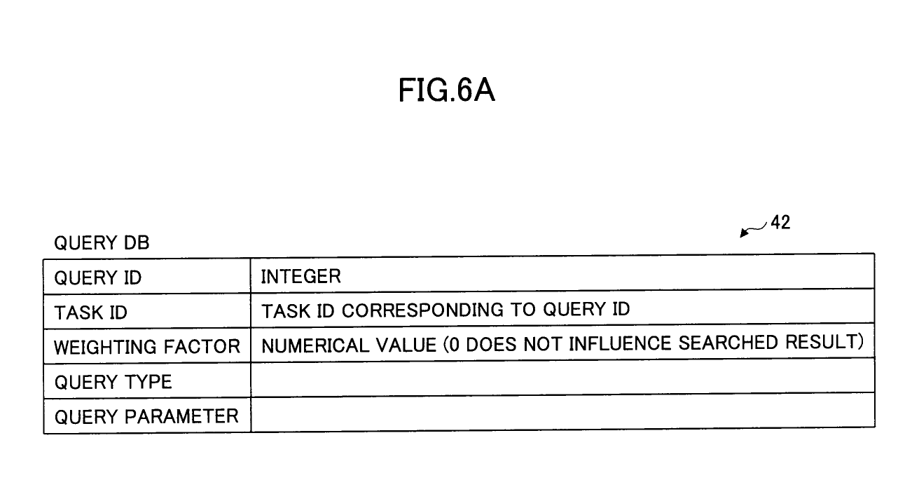

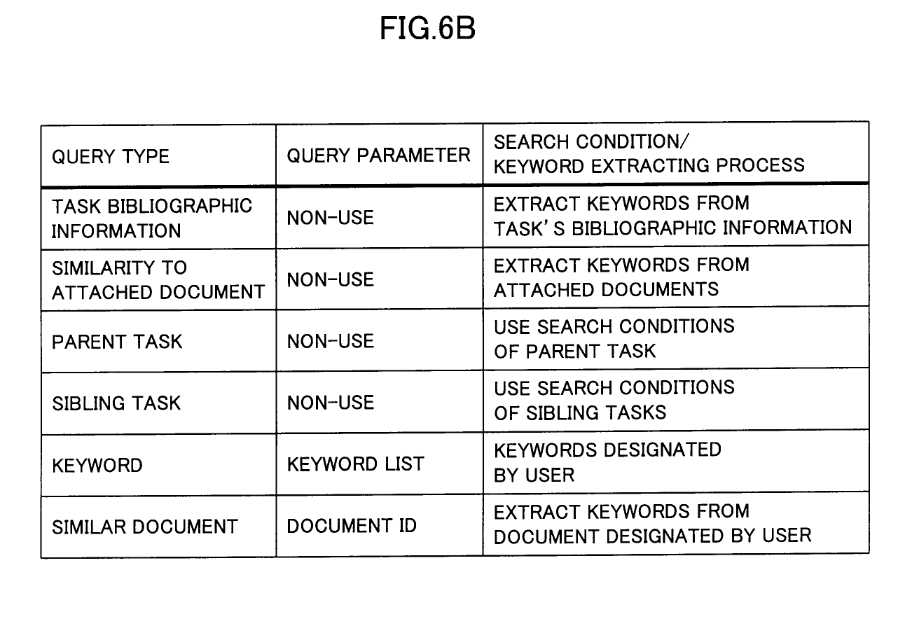

FIG. 6A is a diagram showing an example of a data structure of the query DB 42. As shown in FIG. 6A, the query DB 42 includes a query ID for identifying a search condition (search condition object), a task ID for showing an ID of a task corresponding to the query ID, a weighting factor for showing a weighting factor of the search condition, a query type for showing a type of the search condition, and a query parameter for showing a parameter to be added to the search condition.

FIG. 6B is a diagram showing an example of a correspondence relationship among the query type, the query parameter, and the search condition/keyword extracting process in the query DB 42. The query type “task bibliographic information” does not use a query parameter, and extracts keywords from the task's bibliographic information. The query type “similarity to attached document” does not use a query parameter, and extracts keywords from attached documents. The query type “parent task” does not use a query parameter, and uses search conditions of the parent task. The query type “sibling task” does not use a query parameter, and uses search conditions of sibling tasks. The query type “keyword” uses a keyword list (keyword group) as the query parameter, and keywords designated by a user are used for the search conditions. In addition, the query type “similar document” uses a document ID as the query parameter and extracts keywords from a document designated by a user. The relevance feedback under the relevance condition is handled as a type of the query type “similar document”.

In a search condition by the query type “keyword” or “similar document”, information input by a user is stored as a fixed search condition. In other search conditions, a condition to be used at the search is calculated caused by updating bibliographic information of a task, adding an attached document, and so on. With this, the change of information along with the progress of the tasks is immediately and automatically reflected on a document search result.

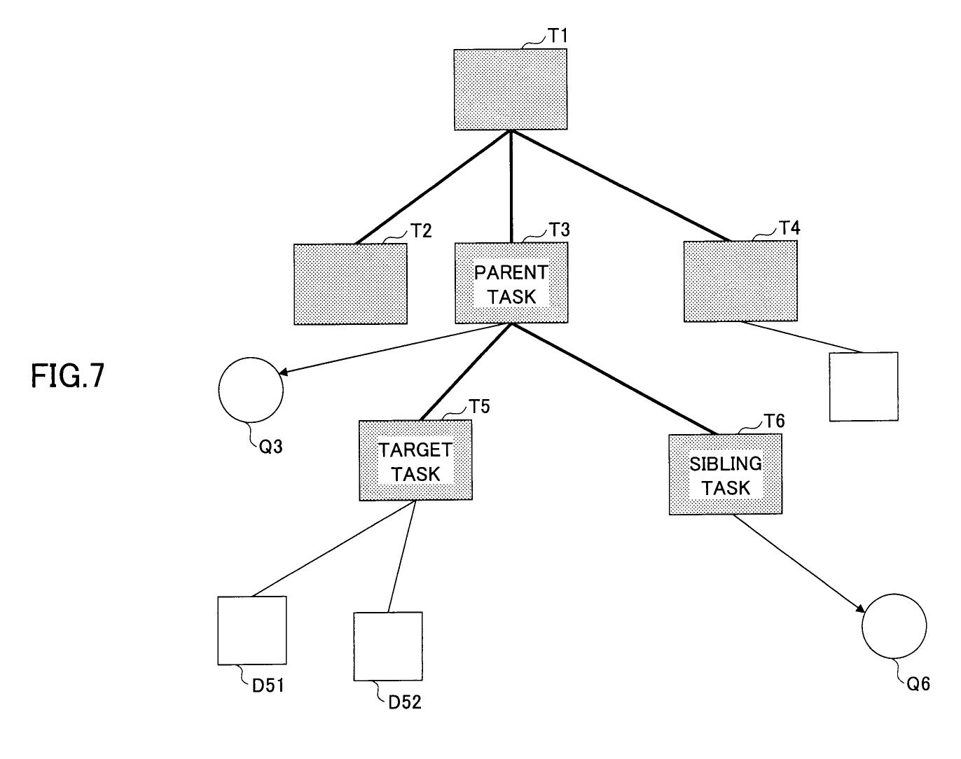

FIG. 7 is a diagram showing an example of a hierarchical structure of tasks including a relationship between search conditions and attached documents. In FIG. 7, tasks T2, T3, and T4 exist as lower tasks of a task T1; tasks T5 and T6 exist as lower tasks of the task T3; and the task T5 is a target task. In the query type “task bibliographic information” shown in FIG. 6B, a keyword extracted from task bibliographic information including in task information of the target task T5 is used for the search. In the query type “similarity to attached document” shown in FIG. 6B, keywords extracted from attached documents D51 and D52 related to the target task T5 are used for the search.

In the query type “parent task” shown in FIG. 6B, a search condition Q3 related to the parent task T3 is used for the search. In the query type “sibling task” shown in FIG. 6B, a search condition Q6 related to the sibling task T6 is used for the search. In addition, in the query type “keyword” shown in FIG. 6B, keywords designated by a user are used for the search, and in the query type “similar document” shown in FIG. 6B, keywords extracted from the document that is designated by a user are used for the search.

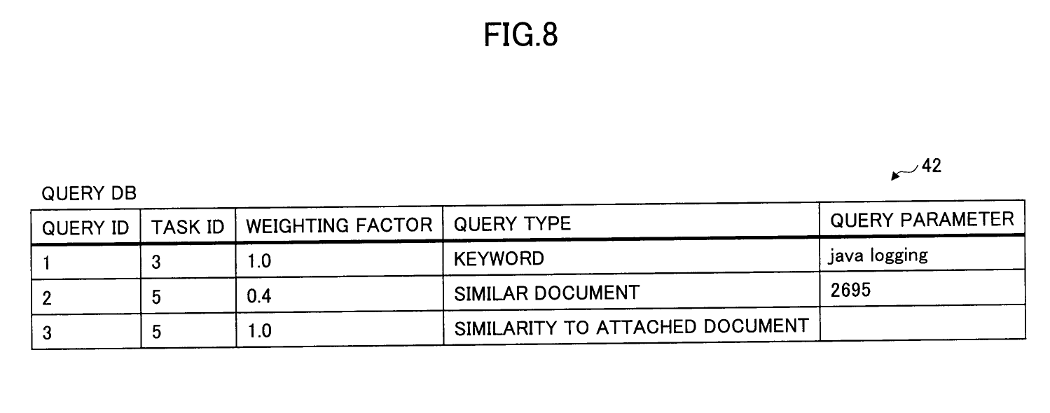

FIG. 8 is a diagram showing a specific example of the query DB 42. In the first line of FIG. 8, a search condition is shown in which the query ID is “1”, the task ID is “3”, the weighting factor is “1.0”, the query type is “keyword”, and the query parameter is “java logging”. That is, the search condition is that the weighting factor is “1.0” and the query parameter is “java logging” as the keyword in the query ID “1” and the task “3”.

In the second line of FIG. 8, a search condition is shown in which the query ID is “2”, the task ID is “5”, the weighting factor is “0.4”, the query type is “similar document”, and the query parameter is “2695”. In this case, keywords are extracted from a document having a document ID “2695” shown by the query parameter, and the weighting factor “0.4” is applied to the obtained keyword. With this the search condition is obtained in the query ID “2” and the task “5”.

In the third line of FIG. 8, a search condition is shown in which the query ID is “3”, the task ID is “5”, the weighting factor is “1.0”, and the query type is “similarity to attached document”. In this case, keywords are extracted from documents attached to the task of the task ID “5” at the search time and the weighting factor “1.0”/the number of the attached documents is applied to the obtained keywords. With this the search condition is obtained in the query ID “3” and the task “5”.

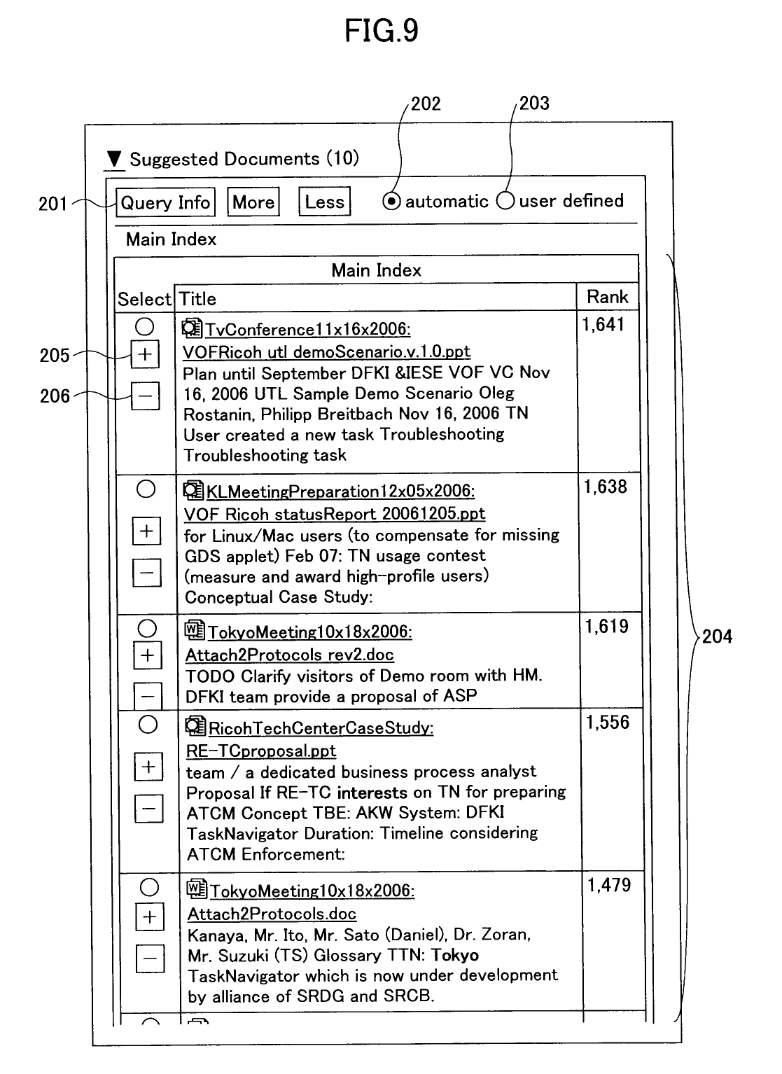

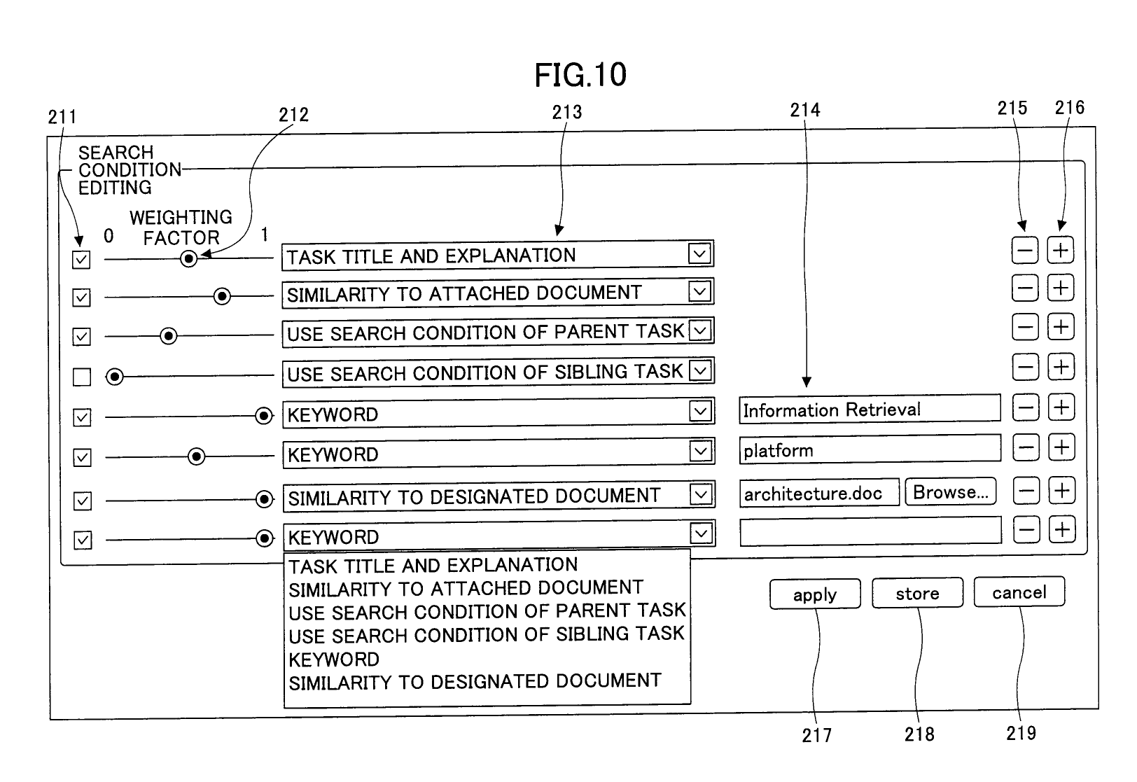

FIG. 9 is a diagram showing an example of a search result displaying screen displayed by the user interface 2. In a search result displaying field 204 of FIG. 9, titles and ranks of search results of document information related to a target task are displayed. When a “Query Info” button 201 is pushed (touched), a search condition determination screen (see FIG. 10 described below) is displayed, and a user can add or delete a search condition and can change a weighting factor. In FIG. 9, an “automatic” button 202 is used to designate a search condition of a fixed weighting factor, and a “user defined” button 203 is used to designate a search by a search condition stored by being related to a task.

A “+” button 205 and a “−” button 206 attached to the document information of each of the search results is used to designate a relevance condition. A document whose “+” button 205 is pushed (touched) is designated to be a document whose query type is “similar document”. With this, a keyword extracted from a designated document is added to a search condition, and as a result, the document can be searched for again by the relevance feedback in a search condition obtaining process described below. In addition a document whose “−” button 206 is pushed (touched) is removed from the search results in which, however, for example, a designated document ID is maintained.

FIG. 10 is a diagram showing an example of the search condition determination screen displayed by the user interface 2.

In FIG. 10, a search condition checked at a search condition selection checkbox 211 becomes effective, and a weighting factor can be designated by using a weighting factor designation slider 212. When a check does not exist at the search condition selection checkbox 211, the value at the weighting factor designation slider 212 becomes “0” in the search condition. A structure can be used in which a numerical value is directly input as the weighting factor instead of using the weighting factor designation slider 212.

In a query type displaying field 213, a default character string (query type) is displayed. However, another query type can be selected by using a pull down menu. In the query type displaying field 213, “task title and explanation” corresponds to the query type “task bibliographic information” shown in FIG. 6B, “similarity to attached document” corresponds to the query type “similarity to attached document” shown in FIG. 6B, “use condition of parent task” corresponds to the query type “parent task” shown in FIG. 6B, “use condition of sibling task” corresponds to the query type “sibling task” shown in FIG. 6B, “keyword” corresponds to the query type “keyword” shown in FIG. 6B, and “similarity to designated document” corresponds to the query type “similar document” shown in FIG. 6B.

When a search condition needs a query parameter, a query parameter inputting field 214 is displayed and a user can input an arbitrary query parameter. When a “−” button 215 formed for a search condition is pushed, the search condition is deleted, and when a “+” button 216 formed for a search condition is pushed, the search condition is added. When an “apply” button 217 is pushed, the search condition is applied to the search, when a “store” button 218 is pushed, the search condition is stored in the query DB 42, and when a “cancel” button 219 is pushed, the determination of the above elements in the search condition determination screen is cancelled.

[Processes]

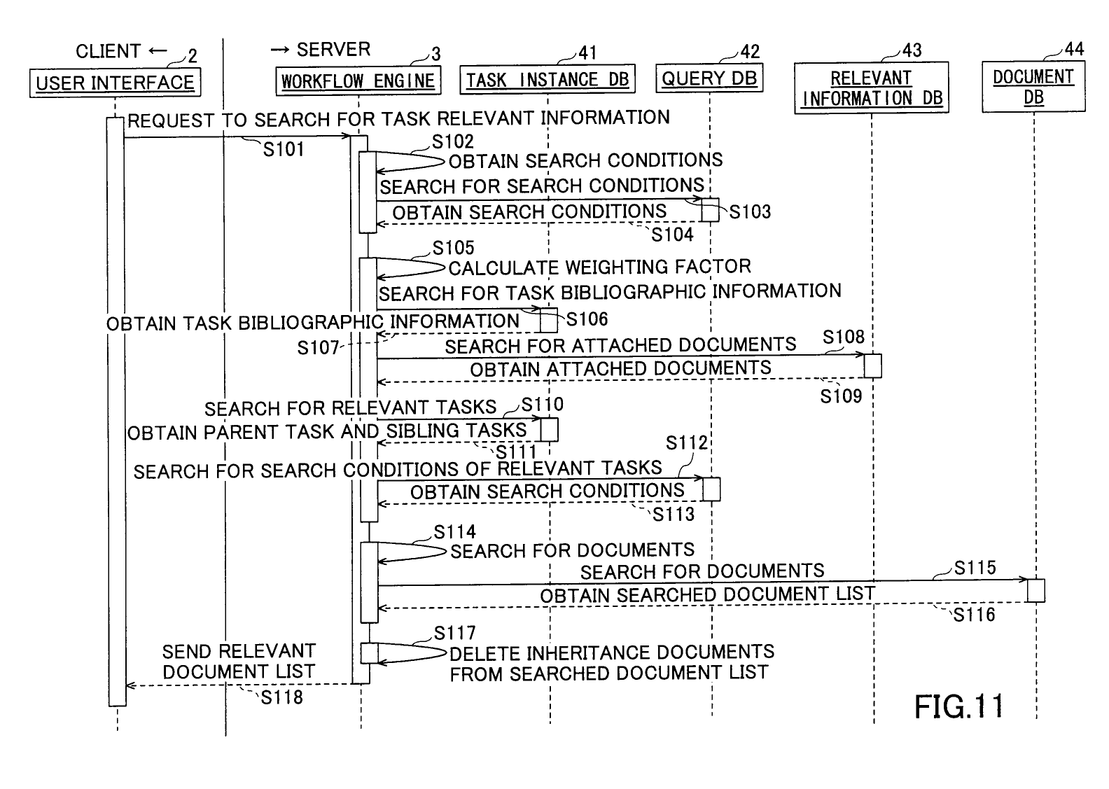

FIG. 11 is a sequence chart of a process example according to the embodiment of the present invention. In FIG. 11, task relevant information is searched for based on a request of the user U.

First, the user interface 2 of a client requests the workflow engine 3 of a server to search for task relating information of a target task (S101). Then the workflow engine 3 obtains search conditions of the target task (search condition obtaining process) (S102). In the search condition obtaining process, the workflow engine 3 obtains the search conditions from the query DB 42 which have been stored in the query DB 42 (S103 and S104) (search condition obtaining process). The search condition obtaining process is described below in detail.

Next, the workflow engine 3 applies a weighting factor calculating process to the obtained search conditions (S105). That is, the workflow engine 3 obtains restructured search conditions having a predetermined format by applying the weighting factor calculating process to the obtained search conditions. In the weighting factor calculating process, the workflow engine 3 obtains task bibliographic information from the task instance DB 41 (S106 and s107), obtains attached documents from the relevant information DB 43, and obtains attached documents from the relevant information DB 43 (S108 and S109), obtains relevance tasks (parent task and sibling tasks) from the task instance DB 41 (S110 and S111), and obtains search conditions of the relevance tasks from the query DB 42 (S112 and S113). The weighting factor calculating process is described below in detail.

Next, the workflow engine 3 searches for documents based on the obtained search conditions described above (S114) (document searching process). In the document searching process, the workflow engine 3 searches for documents in the document DB 44 (S115), and obtains a searched document list (S116). In addition, the workflow engine 3 deletes inheritance documents from the searched document list (S117). As described above, the inheritance document is a relevant document of an ancestor task of a target task and is inherited by the target task from the ancestor task. The inheritance document is determined by the parent-child relationship of a task in the task instance DB 41 and information stored in the relevant information DB 43, and is displayed at a predetermined part of a task management screen (not shown) as a relevant document of an ancestor task. With this, the inheritance document is not doubly displayed in the relevant document list, and many relevant documents can be displayed.

Next, the workflow engine 3 of the server sends a document list obtained in S117 to the user interface 2 of the client as a relevant document list (S118). The user interface 2 displays the relevant document list on a screen similar to the search result displaying screen shown in FIG. 9.

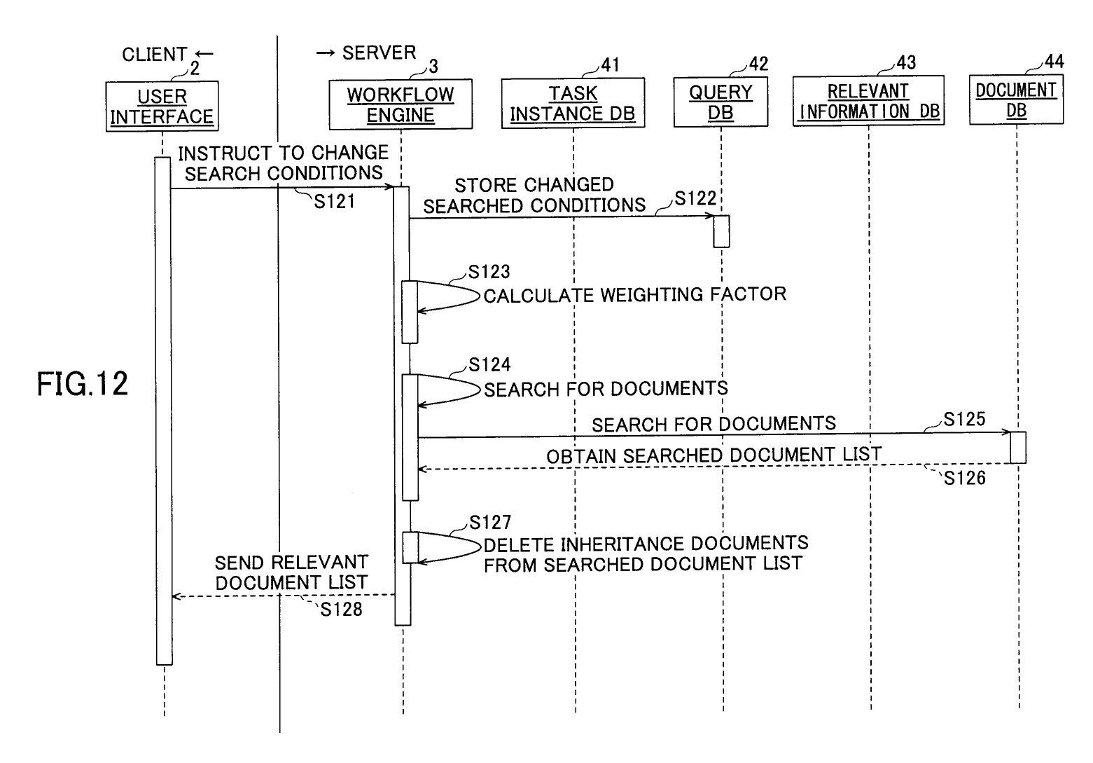

FIG. 12 is a sequence chart of another process example according to the embodiment of the present invention. In FIG. 12, task relevant information is searched for again after changing the search conditions (including the designation of the weighting factor) by the user U.

First, the user interface 2 of the client instructs the workflow engine 3 of the server to change a search condition on a screen similar to the search condition determining screen shown in FIG. 10 (S121). The workflow engine 3 stores the changed search conditions in the query DB 42 (S122).

Next, the workflow engine 3 applies a weighting factor calculating process to the stored search condition (S123). In the weighting factor calculating process, the workflow engine 3 accesses to the task instance DB 41, the query DB 42, and the relevant information DB 43. The weighting factor calculating process is described below in detail.

Next, the workflow engine 3 searches for documents based on the search condition determined above (document searching process) (S124). In the document searching process, the workflow engine 3 searches for documents in the document DB 44 (S125), and obtains a searched document list (S126). In addition, the workflow engine 3 deletes inheritance documents from the searched document list (S127).

Next, the workflow engine 3 of the server sends the document list obtained in S127 to the user interface 2 of the client as a relevant document list (S128). The user interface 2 displays the relevant document list on a screen similar to the search result displaying screen shown in FIG. 9.

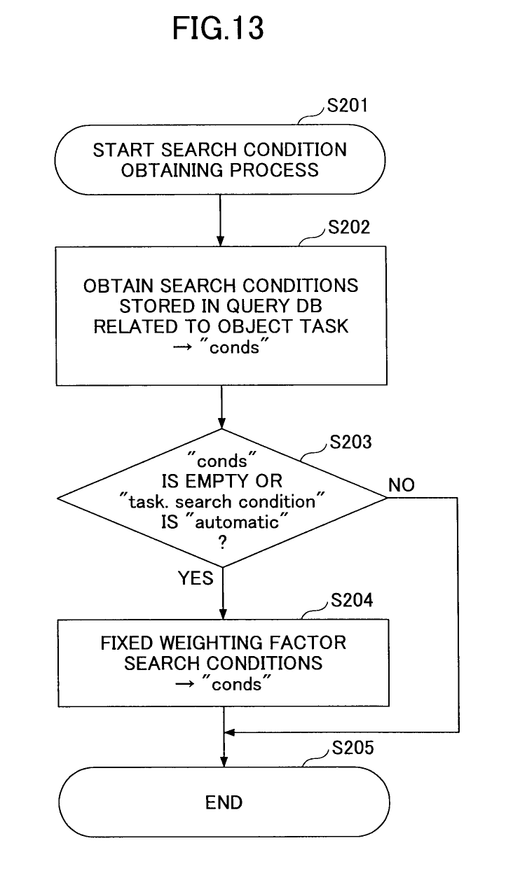

FIG. 13 is a flowchart showing an example of the search condition obtaining process shown in S102 of FIG. 11 by the workflow engine 3.

In FIG. 13, first, the search condition obtaining process starts when the workflow engine 3 receives an object task (target task) as an argument from the user interface 2 (S201).

Next, the workflow engine 3 obtains search conditions which have been stored in the query DB 42 by being related to the object task and sets the obtained search conditions in a search condition group “conds” (S202).

Next, the workflow engine 3 determines whether the search condition group “conds” is empty or “task. search condition” (property “search condition” of object “task”) is “automatic” (S203). When the search condition group “conds” is not empty and “task. search condition” is not “automatic” (NO in S203), the workflow engine 3 ends the search condition obtaining process (S205).

When the search condition group “conds” is empty or “task. search condition” is “automatic” (YES in S203), the workflow engine 3 sets a fixed weighting factor search condition in the search condition group “conds” (S204), and the workflow engine 3 ends the search condition obtaining process (S205).

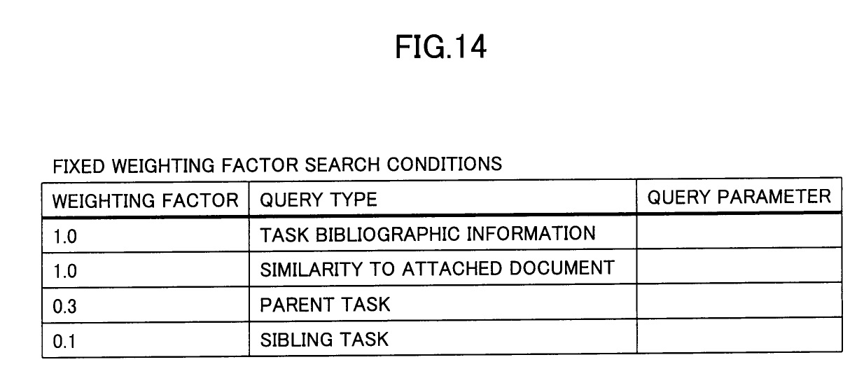

FIG. 14 is a diagram showing an example of the fixed weighting factor search condition. In FIG. 14, “weighting factor”, “query type”, and “parameter” have been stored in the query DB 42 beforehand by being related with each other. In FIG. 14, the weighting factor of the query type “task bibliographic information” is determined to be “1.0”, the weighting factor of the query type “similarity to attached document” is determined to be “1.0”, the weighting factor of the query type “parent task” is determined to be “0.3”, and the weighting factor of the query type “sibling task” is determined to be “0.1”. When a user changes the weighting factor of a query type, a search condition can be adjusted even if the user does not explicitly determine the search condition. For example, when the weighting factor of a sibling task is determined to be a negative value, a difference between the sibling task and the target task can be emphasized in the search result.

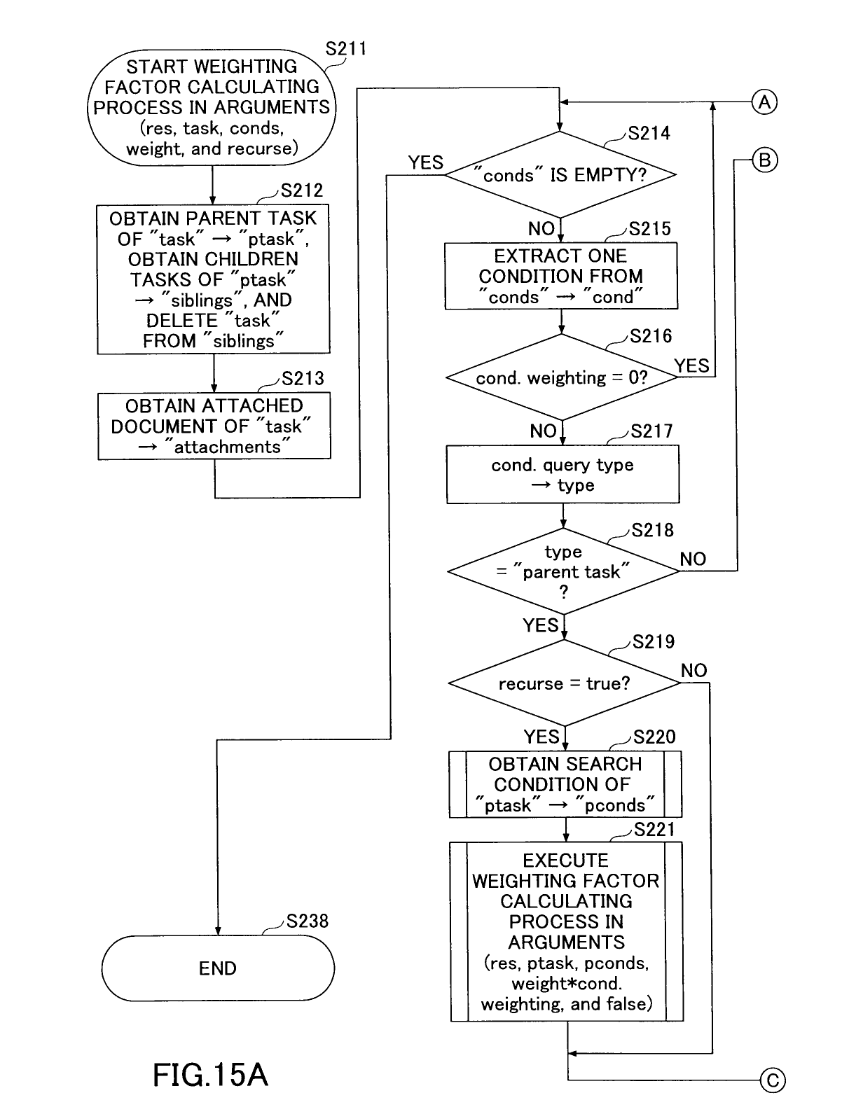

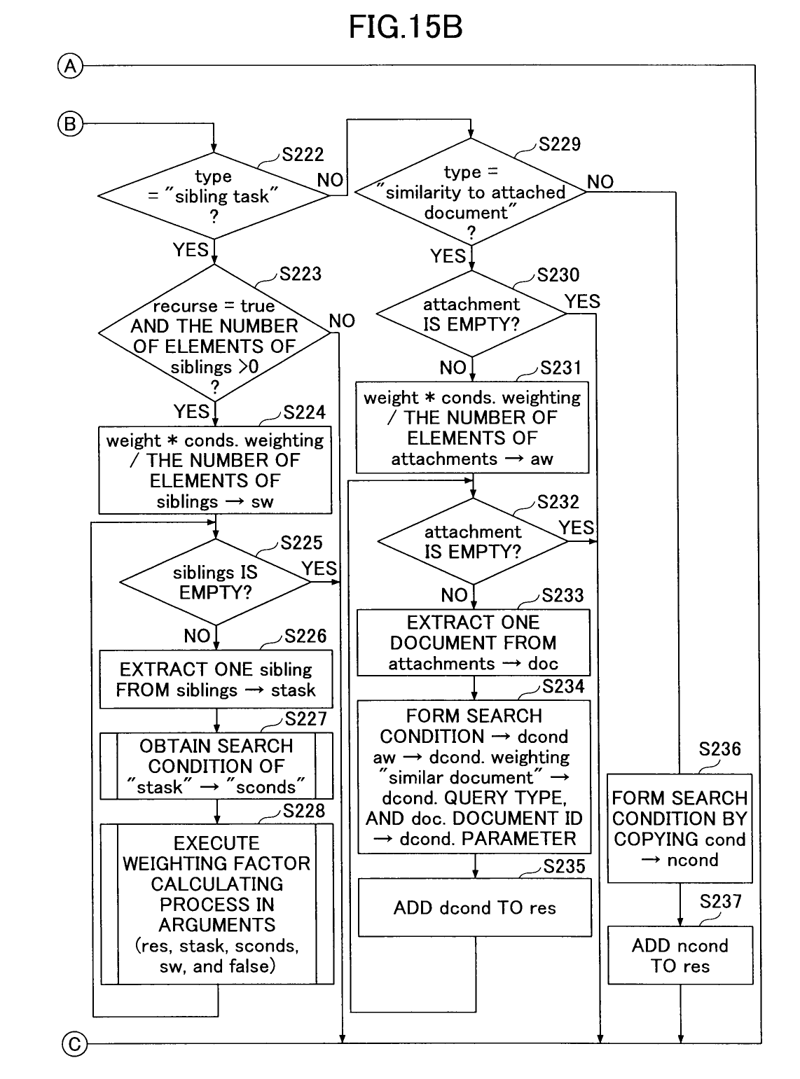

FIG. 15A is a first flowchart showing an example of the weighting factor calculating process shown in S105 of FIGS. 11 and S123 of FIG. 12 by the workflow engine 3. FIG. 15B is a second flowchart showing an example of the weighting factor calculating process shown in S105 of FIG. 11 and S123 of FIG. 12 by the workflow engine 3.

FIG. 15B is connected to FIG. 15A; therefore, the weighting factor calculating process is described by referring to FIGS. 15A and 15B.

In the process, search condition using information of a relevant task is converted into a search condition which has been stored in the relevant task. For example, the search condition of the query type “parent task” is converted into plural search conditions which have been stored by being related to the parent task. A product of a weighting factor designated in a search condition of a current task and a weighting factor stored in a parent task is determined to be a new weighting factor. In the search condition by the sibling task and the attached document, the weighting factor is normalized to be a weighting factor designated in the total so that a difference caused by the number of the sibling tasks and the number of the attached documents does not cause a problem. The weighting factors of the parent task and the sibling task are determined by a recursive call of the weighting factor calculating process. A “parent task” and a “sibling task” may be designated as the search condition of a sibling task; therefore, a task may be processed plural times by a recursive call.

In FIG. 15A, the workflow engine 3 receives a result retention sequence “res”, an object task “task”, a search condition group “conds”, a weighting factor “weight”, and a recursive call “recurse” as arguments from the user interface 2, and starts the weighting factor calculating process (S211). When the weighting factor calculating process is normally called (is not a recursive call), the result retention sequence “res” is empty, the object task “task” is a task ID of a task to which information is supplied, the search condition group “conds” is a search condition obtained from the query DB 42, the weighting factor “weight” is a default value “1.0”, and the recursive call “recurse” is “true”.

Next, the workflow engine 3 obtains a parent task of the object task “task” and determines the parent task to be “ptask”, obtains children tasks of the parent task “ptask” and determines the children tasks to be a sibling task group “siblings”, and deletes the object task (target task) from the sibling tasks group “siblings” (S212).

Next, the workflow engine 3 obtains documents attached to the object task “task” (attached documents) and determines the attached documents to be an attached document group “attachment” (S213).

Next, the workflow engine 3 determines whether the search condition group “conds” is empty (S214). When the search condition group “conds” is empty (YES in S214), the workflow engine 3 ends the weighting factor calculating process (S238).

When the search condition group “conds” is not empty (NO in S214), the workflow engine 3 extracts one search condition from the search condition group “conds”, and determines the extracted search condition to be a search condition “cond” S215).

Next, the workflow engine 3 determines whether a property “cond. weighting” of the search condition “cond” is “0” (S216). When a property “cond. weighting” of the search condition “cond” is “0” (YES in S216), the process returns to S214.

When a property “cond. weighting” of the search condition “cond” is not “0” (NO in S216), the workflow engine 3 obtains a query type of the property “cond.” of the search condition “cond” and determines the obtained type to be a query type “type” (S217).

Next, the workflow engine 3 determines whether the query type “type” is “parent task” (S218). When the query type “type” is not “parent task” (NO in S218), the workflow engine 3 determines whether the query type “type” is “sibling task” (S222). When the query type “type” is not “sibling task” (NO in S222), the workflow engine 3 determines whether the query type “type” is “similarity to attached document” (S229).

When the query type “type” is “parent task” (YES in S218), the workflow engine 3 determines whether the recursive call “recurse” is “true” (S219).

When a normal call is executed, the recursive call “recurse” is “true” (YES in S219); the workflow engine 3 calls up the search condition obtaining process shown in FIG. 13 by determining the parent task “ptask” to be the argument and the workflow engine 3 sets the processed result in a parent task searching condition group “pconds” (S220).

Next, the workflow engine 3 recursively calls up the processes on and after S211 in which the result retention sequence “res”, the parent task “ptask”, the parent task search condition group “pconds”, the weighting factor “weight*cond. weighting”, and the recursive call “recurse=false” are arguments (S221), and the process returns to S214. In order to limit the depth of the recursive call to be “1”, the recursive call is determined to be “false”. The depth of the recursive call can be controlled by using processed tasks and an integrated value of weighting factors without using the recursive call “recurse”.

When the recursive call “recurse” is not “true” (NO in S219), the search condition obtaining process (S220) and the weighting factor calculating process (S221) are not executed.

When the query type “type” is “sibling task” (YES in S222), the workflow engine 3 determines whether the recursive call “recurse” is “true” and the number of elements in the sibling task group “siblings” is greater than “0” (S223). When the recursive call “recurse” is not “true” or the number of elements in the sibling task group “siblings” is not greater than “0” (NO in S223), the process returns to S214.

When the recursive call “recurse” is “true” and the number of elements in the sibling task group “siblings” is greater than “0” (YES in S223), the workflow engine 3 divides a product of the weight factor “weight” and “cond. weighting” by the number of elements of the sibling task group “siblings”, and the calculated result is determined to be a sibling task weighting factor “sw” (S224).

Next, the workflow engine 3 determines whether the sibling task group “siblings” is empty (S225). When the sibling task group “siblings” is empty (YES in S225), the process returns to S214.

When the sibling task group “siblings” is not empty (NO in S225), the workflow engine 3 extracts one sibling task from the sibling task group “siblings” and determines the extracted sibling task to be a sibling task “stask” (S226).

Next, the workflow engine 3 calls up the search condition obtaining process shown in FIG. 13 in which the sibling task “stask” is determined to be an argument, and sets the obtained search condition in a sibling task search condition group “sconds” (S227).

Next, the workflow engine 3 recursively calls up the processes on and after S211 in which the result retention sequence “res”, the sibling task “stask”, the sibling task search condition group “sconds”, the sibling task weighting factor “sw”, and the recursive call “recurse=false” as arguments (S228), and the process returns to S225.

When the query type “type” is “similarity to attached document” (YES in S229), the workflow engine 3 determines whether the attached document group “attachments” is empty (S230). When the attached document group “attachments” is empty (YES in S230), the process returns to S214.

When the attached document group “attachments” is not empty (NO in S230), the workflow engine 3 divides a product of the weight factor “weight” and “cond. weighting” by the number of elements of the attached document group “attachments”, and the calculated result is determined to be an attached document weighting factor “aw” (S231).

Next, the workflow engine 3 determines whether the attached document group “attachments” is empty (S232). When the attached document group “attachments” is empty (YES in S232), the process returns to S214 where it is determined whether the search condition group “conds” is empty.

When the attached document group “attachments” is not empty (NO in S232), the workflow engine 3 extracts one document from the attached document group “attachments” and determines the extracted document to be a document “doc” (S233).

Next, the workflow engine 3 forms a search condition and sets the formed search condition in an attached document search condition “dcond”, sets an attached document weighting factor “aw” in “dcond. weighting”, sets “similar document” in the query type, and sets “doc. document ID” in “dcond. parameter” (S234).

Next, the workflow engine 3 adds the attached document search condition “dcond” to the result retention sequence “res” (S235), and the process returns to S232 where it is determined whether the attached document group “attachments” is empty.

When the query type “type” is not “similarity to attached document” (NO in S229), the workflow engine 3 copies the search condition “cond”, sets the copied search condition in a next time search condition “ncond”, and sets “ncond. weighting*weight” in “ncond. weighting” (S236).

Next, the workflow engine 3 adds the next time search condition “ncond” to the result retention sequence “res” (S237) and the process returns to S214 where it is determined whether the search condition group “conds” is empty.

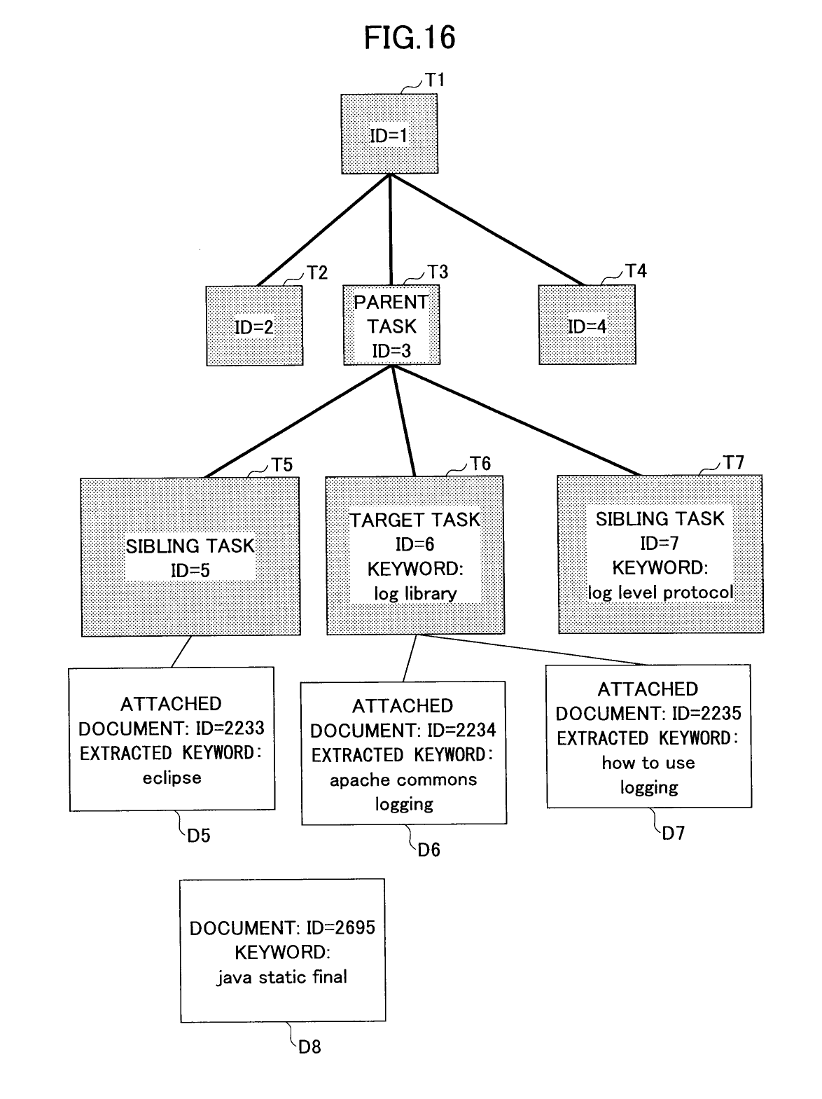

FIG. 16 is a diagram showing a specific example of a weighting factor calculation.

In FIG. 16, tasks T2, T3, and T4 exist under a task T1, and tasks T5, T6, and T7 exist under the task T3. The task T6 is a target task to which information is supplied. In addition, an attached document D5 is related to the task T5, and attached documents D6 and D7 are related to the task T6. A document D8 is not related to any one of the tasks T1 through T7.

In a case of a task structure (hierarchical structure) shown in FIG. 16, in the weighting factor calculating process shown in FIG. 15, the tasks T5 and T7, which are sibling tasks of the target task T5, are included in the sibling task group “siblings”. That is, first, the children tasks T5, T6, and T7 (corresponding IDs are 5, 6, and 7) of the parent task T3 (ID=3) are included in the sibling task group “siblings”, and the target task T6 (ID=6) is deleted from the sibling task group “siblings”. Consequently, the tasks T5 and T7 remain in the sibling task group “siblings”.

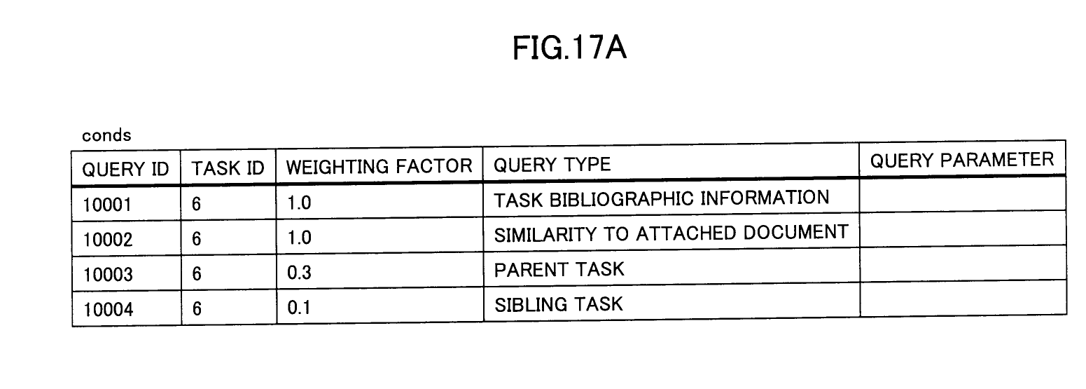

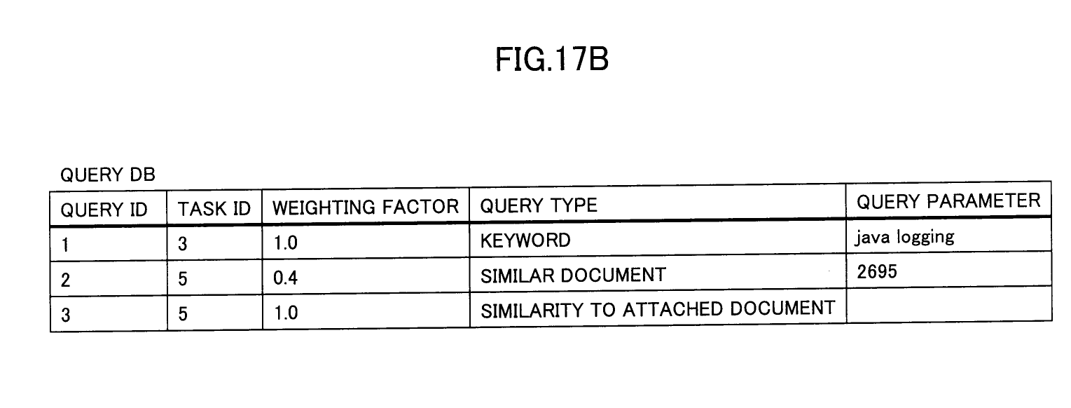

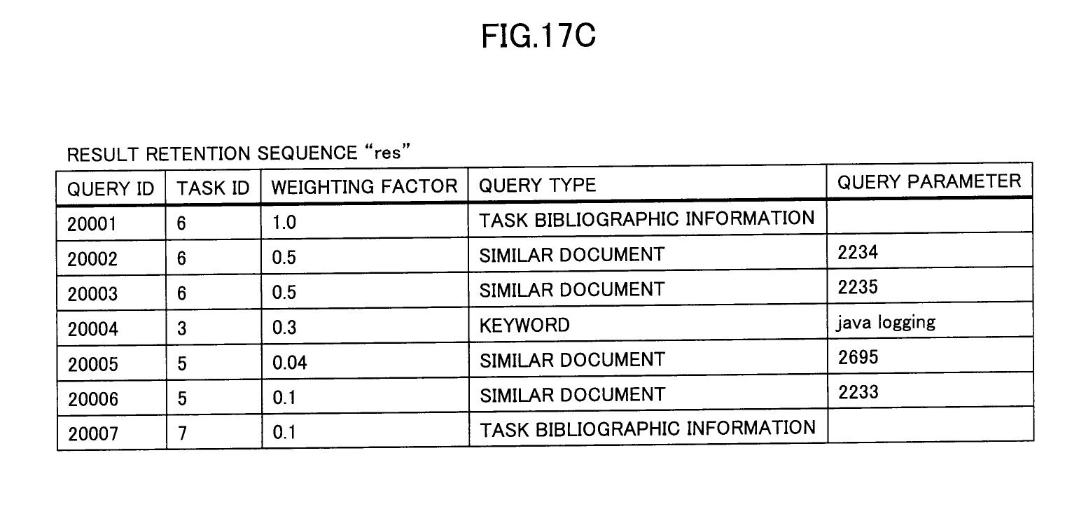

FIG. 17A is a diagram showing an example of the search condition group “conds” in which the fixed weighting factor search condition shown in FIG. 14 is applied to the target task T6 to which information is supplied. The search condition group “conds” holds search condition objects (lines in FIG. 17A) as a list, and the search objects are extracted one by one from the search condition group “conds”, and the extracted search condition object is processed.

FIG. 17B is a diagram showing an example of contents of the query DB 42. In the first line of FIG. 17B, the search condition is formed of the query ID “1”, the task ID “3”, the weighting factor “1.0”, the query type “keyword”, and the query parameter “java logging”. That is, in the search condition, the weighting factor “1.0” is applied to the keywords “java” and “logging”.

In the second line of FIG. 17B, the search condition is formed of the query ID “2”, the task ID “5”, the weighting factor “0.4”, the query type “similar document”, and the query parameter “2695”. That is, in the search condition, the weighting factor “0.4” is applied to keywords extracted from a document whose document ID is 2695 (query parameter).

In the third line of FIG. 17B, the search condition is formed of the query ID “3”, the task ID “5”, the weighting factor “1.0”, and the query type “similarity to attached document”. That is, in the search condition, the weighting factor “1.0/the number of attached documents” is applied to keywords extracted from documents attached to the task whose task ID is “5”.

FIG. 17C is a diagram showing a result retention sequence “res” when the weighting factor calculating process shown in FIG. 15 is applied to the examples shown in FIGS. 17A and 17B.

In FIG. 17C, the query ID “20001” is formed by copying the query ID “10001” shown in FIG. 17A. The query IDs “20002” and “20003” correspond to the query ID “10002” shown in FIG. 17A, and since the number of attached documents to the task T6 is two, the weighting factor becomes “0.5” each, and the query type is converted into “similar document” of the documents IDs “2234” and “2235”.

The query ID “20004” corresponds to the query ID “10003” shown in FIG. 17A, and the search condition of the query ID “1” shown in FIG. 17B which is the search condition of the parent task (ID=3) is copied and the weighting factor “0.3” is multiplied.

The query IDs “20005” and “20006” correspond to the query ID “10004” shown in FIG. 17A, and a weighting factor “0.1” is multiplied by the search condition of the query ID “2” and “3” shown in FIG. 17B which is the search condition of the sibling task (ID=3). The query type “similarity to attached document” is converted into the query type “similar document” of the document ID “2233”. The query ID “20007” corresponds to the query ID “10004” shown in FIG. 17A and a weighting factor “0.1” is multiplied by the search condition (the fixed weighting factor of the task 7) of the sibling task (ID=7).

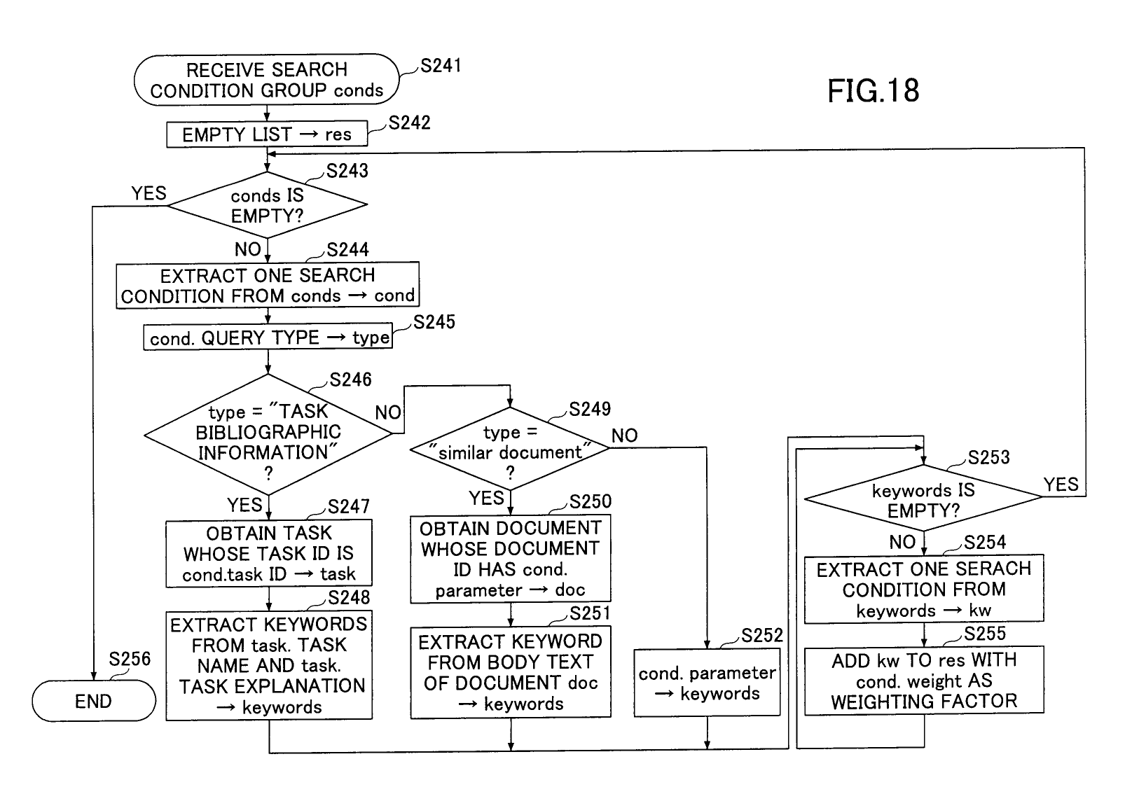

FIG. 18 is a flowchart showing a process example in which a search condition is converted into a keyword. The process is executed at an initial stage or right before the document search process shown in S114 of FIG. 11 and S124 of FIG. 12. That is, the list of the search conditions including the weighting factors is obtained by the above processes. By the process in which the search condition is converted into the keyword, a search can be executed by using the document searching section 32 (search engine).

In a well-known vector model search engine, a search is executed by using a pair of a keyword and a weighting factor. In another vector model search engine, a similar document is searched for by designating a document ID and a weighting factor in addition to using the paired keyword and weighting factor. In the following description, the search is executed by using the search engine to which a keyword and a weighting factor are given. However, a similar document can be searched for in which weighting factors corresponding to document IDs are accumulated without extracting a keyword from a document.

In FIG. 18, first, the process, in which a search condition is converted into a keyword, starts when the workflow engine 3 receives a search condition group “conds” as an argument (S241).

Next, the workflow engine 3 sets an empty list in the result retention sequence “res” (S242).

Next, the workflow engine 3 determines whether the search condition group “conds” is empty (S243). When the search condition group “conds” is empty (YES in S243), the process ends (S256).

When the search condition group “conds” is not empty (NO in S243), the workflow engine 3 extracts one search condition from the search condition group “conds” and determines the extracted search condition to be a search condition “cond” (S244).

Next, a “cond. query type” is set in a query type (S245). Then, the workflow engine 3 determines whether the query type is “task bibliographic information” (S246). When the query type is not “task bibliographic information” (NO in S246), the workflow engine 3 determines whether the query type is “similar document” (S249).

When the query type is “task bibliographic information” (YES in S246), the workflow engine 3 obtains a task whose task ID is a “cond. task ID” and determines the obtained task to be a target task (S247).

Next, the workflow engine 3 extracts a keyword from “task. task name” and “task. task explanation” and sets the extracted keyword in a keyword group “keywords” (S248).

When the query type is “similar document” (YES in S249), the workflow engine 3 obtains a document whose document ID has “cond. parameter” and sets the document in a document “doc” (S250).

Next, the workflow engine 3 extracts a keyword from a body text of the document “doc” and sets the extracted keyword in a keyword group “keywords” (S251).

When the query type is not “similar document” (NO in S249), the workflow engine 3 sets “cond. parameter” in the keyword group “keywords” (S252).

After setting keywords in the keyword group “keywords” (S248, S251, and S252), the workflow engine 3 determines whether the keyword group “keywords” is empty (S253). When the keyword group “keywords” is empty (YES in S253), the process returns to S243 where the workflow engine 3 determines whether the search condition group “conds” is empty.

When the keyword group “keywords” is not empty (NO in S253), the workflow engine 3 extracts one search condition from the keyword group “keywords” and determines the extracted search condition to be a keyword “kw” (S254).

Next, the workflow engine 3 adds the keyword “kw” to the result retention sequence “res” with “cond. weight” as the weighting factor (S255), and the process returns to S253 where the workflow engine 3 determines whether the keyword group “keywords” is empty.

By the processes described above, the bibliographic information, the attached document information, and the hierarchical structure information of the tasks are internally expressed as a weighting factor list corresponding to keywords. When the document searching section 32 searches for a document based on the weighting factor list, a search result on which the information is reflected can be obtained. When a user adds or deletes a search condition, a document to be searched for can be controlled, and the user can control a displaying order (ranking) of the search result by changing weighting factors. In addition, when the search conditions and the weighting factors are stored, the designation of the search conditions and the weighting factors can be omitted from the next time on, and the search can be executed based on the updated information.

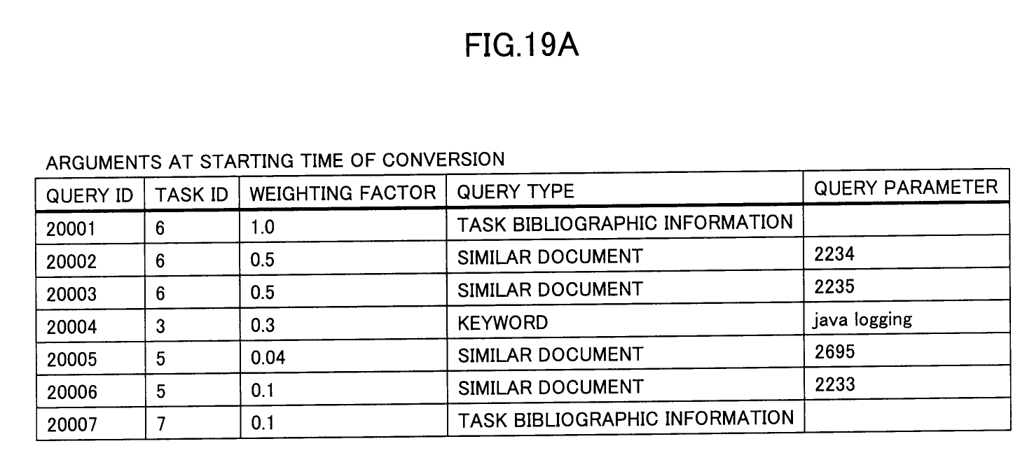

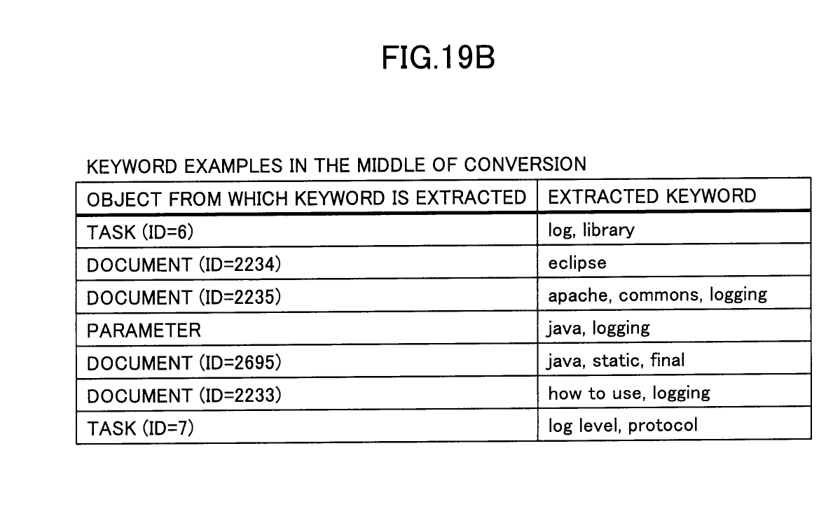

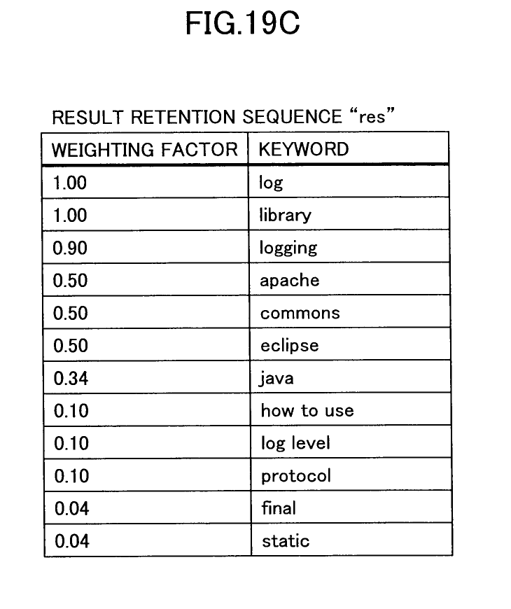

FIG. 19A is a diagram showing a specific example of the search condition group “conds” which contains arguments at a starting time of the conversion of search conditions into keywords. FIG. 19B is a diagram showing specific examples of keywords to be extracted in the middle of the conversion. FIG. 19C is a diagram showing a specific example of a result retention sequence “res” in which the weighting factors and the keywords are shown.

In FIG. 19C, keywords “log” and “library” extracted from bibliographic information of a task 6, keyword obtained from similar documents of the task 6, and keywords obtained from tasks T3, T5, and T7 positioned neighboring to the task 6 in the hierarchical structure are used for the search. The weighting factor is added in each keyword. In FIG. 19C, the keywords are sorted by the weighting factors; however, the order is not limited to the above.

As described above, according to the embodiment of the present invention, the following advantages can be obtained.

First, documents are searched for by using (document) search conditions related to a given task (target task), the searched for and obtained documents are displayed as a list, and the document search conditions have been stored by being related to the target task. Therefore, when relevant documents of the same task are searched for later, the stored document search conditions can be used again.

In addition, since the document search conditions are automatically formed from bibliographic information of the task, the relevant documents can be searched for without explicitly designating the document search conditions. Further, when the bibliographic information has been updated, the updated bibliographic information can be automatically reflected on the document search result.

In addition, since the document search conditions are automatically formed from documents attached to the task, the relevant documents can be easily searched for.

In addition, since the document search conditions input by a user have been stored by being related to the task, when relevant documents of the same task are searched for later, the stored document search conditions can be used again.

In addition, since the user can select one of the automatically formed or stored document search conditions, the user can search for relevant documents by using the selected document search condition.

In addition, since the user can give a weighting factor to each of the automatically formed or stored document search conditions, the user can obtain a relevant document search result under plural conditions.

In addition, since a task hierarchical structure is used for tasks, the user can use again document search conditions which have been stored by being related to neighboring tasks to the task.

In addition, since a weighting factor of a designated document search condition can be stored, the weighting factor can be used again.

In addition, since a fixed weighting factor can be used, the relevant documents can be searched for by utilizing bibliographic information and document search conditions of tasks neighboring to the task on the hierarchical structure by using the fixed weighting factor without explicitly designating the document search conditions by the user.

In addition, since the next time search can be executed by using the stored weighting factors and the stored document search conditions, the relevant documents can be searched for by using keywords extracted with the use of a TF-IDF (term frequency-inverse term frequency) method.

In addition, since the document search can be executed again by selecting a strong relevance document or a weak relevance document from a displayed relevant document list, the search result list can be modified by the relevance feedback, and the selected result can be stored and reused. Further, the relevance feedback can be reflected on the document search conditions when the document search is executed for tasks neighboring to the designated task (target task).

In addition, since relevant documents of an ancestor task, which are displayed as inheritance documents, on a part of a screen are not displayed on the relevant document list by being overlapped, many unattached documents can be displayed.

Further, the present invention is not limited to the specifically disclosed embodiment, and variations and modifications may be made without departing from the scope of the present invention.

The present invention is based on Japanese Priority Patent Application No. 2008-230006, filed on Sep. 8, 2008, and Japanese Priority Patent Application No. 2009-181878, filed on Aug. 4, 2009, with the Japanese Patent Office, the entire contents of which are hereby incorporated herein by reference.

What is claimed is:

1. A workflow management system; which manages a constructive workflow, in which procedures of processes are expressed in a hierarchical structure by recursive decomposition of a plurality of tasks each of which is a unit of the process, and the constructive workflow is capable of executing at least one of adding, editing, and deleting a task while processing the procedures; comprising:
a storing unit, to which a user inputs a search condition to search for documents relevant to a target task and tasks neighboring to the target task, and which stores the input search condition in a query database by causing the input search condition to relate to the target task;
a search condition obtaining unit which obtains a search condition to search for the documents relevant to the target task from the query database when the documents relevant to the target task are requested to be searched for;
a restructuring unit which restructures the obtained search condition to a search condition having a predetermined format by considering a type and a weighting factor of the type included in the obtained search condition; and
a searching unit which obtains a list of documents from a document database based on the restructured search condition.

2. The workflow management system as claimed in claim 1, wherein:
the neighboring tasks include at least one of
a parent task whose task ID is a parent task ID as a property value for the target task;
a child task whose task ID is a child task ID as a property value for the target task;
a sibling task whose task ID is a sibling task ID as a property value for the parent task and whose parent task is in common with the target task; and
ancestor tasks including a root task positioned on a path from the target task to the root task in the hierarchical structure.

3. The workflow management system as claimed in claim 1, wherein:
the search condition to be stored in the query database as the type includes at least one of
a query type “task bibliographic information” in which a keyword is extracted from task bibliographic information of the target task;
a query type “similarity to attached document” in which a keyword is extracted from a document attached to the target task;
a query type “parent task” in which a search condition of the parent task of the target task is used;
a query type “sibling task” in which a search condition of the sibling task of the target task is used;
a query type “keyword” in which a keyword designated by the user is used; and
a query type “similar document” in which a keyword is extracted from a document designated by the user.

4. The workflow management system as claimed in claim 3, further comprising:
a selecting unit which selects a search condition corresponding to the query type; and
an inputting unit which inputs a weighting factor to the search condition selected by the selecting unit.

5. The workflow management system as claimed in claim 3, further comprising:
a relevance feedback applying unit which applies relevance feedback to a document designated from the list of documents.

6. The workflow management system as claimed in claim 3, wherein:
the restructuring unit for restructuring the obtained search condition
copies the query type “task bibliographic information” as it is;
converts the query type “similarity to attached document” into the query type “similar document” in which each attached document is designated by the user;
recursively restructures the query type “parent task” by making the parent task a center;
recursively restructures the query type “sibling task” by making the sibling task a center;
copies the query type “keyword” as it is; and
copies the query type “similar document” as it is.

7. The workflow management system as claimed in claim 1, wherein:
the search condition obtaining unit obtains a search condition to which a fixed weighting factor is attached when a search condition corresponding to a requested task does not exist in the query database, or an automatic search is designated.

8. The workflow management system as claimed in claim 1, further comprising:
a deleting unit which deletes an inheritance document inherited from an ancestor task to a requested task from the list of documents.

9. A workflow management control method in a workflow management system, which manages a constructive workflow, in which procedures of processes are expressed in a hierarchical structure by recursive decomposition of a plurality of tasks each of which is a unit of the process, and the constructive workflow is capable of executing at least one of adding, editing, and deleting a task while processing the procedures; comprising the steps of:
forming a storing unit, to which a user inputs a search condition to search for documents relevant to a target task and tasks neighboring to the target task, and which stores the input search condition in a query database by causing the input search condition to relate to the target task;
forming a search condition obtaining unit which obtains a search condition to search for the documents relevant to the target task from the query database when the documents relevant to the target task are requested to be searched for;
forming a restructuring unit which restructures the obtained search condition to a search condition having a predetermined format by considering a type and a weighting factor of the type included in the obtained search condition; and
forming a searching unit which obtains a list of documents from a document database based on the restructured search condition.

10. A computer-readable recording medium storing a workflow management control program for executing a workflow management control method in a workflow management system, which manages a constructive workflow, in which procedures of processes are expressed in a hierarchical structure by recursive decomposition of a plurality of tasks each of which is a unit of the process, and the constructive workflow is capable of executing at least one of adding, editing, and deleting a task while processing the procedures; wherein:
the workflow management control program includes the steps of
forming a storing unit, to which a user inputs a search condition to search for documents relevant to a target task and tasks neighboring to the target task, and which stores the input search condition in a query database by causing the input search condition to relate to the target task;
forming a search condition obtaining unit which obtains a search condition to search for the documents relevant to the target task from the query database when the documents relevant to the target task are requested to be searched for;
forming a restructuring unit which restructures the obtained search condition to a search condition having a predetermined format by considering a type and a weighting factor of the type included in the obtained search condition; and
forming a searching unit which obtains a list of documents from a document database based on the restructured search condition.
